(19) United States
(12) Patent Application Publication
(10) Pub. No.: US 2003/0044558 A1
(43) Pub. Date: Mar. 6, 2003

(54) Self closing resealable package material with pressure sensitive adhesive strip

(76) Inventors: James E. Lee, Cambridge, MD (US); Patricia L. Lee, Cambridge, MD (US)

Correspondence Address: WINSTON & STRAWN, PATENT DEPARTMENT, 1400 L STREET, N.W., WASHINGTON, DC, 20005-3502, US

(21) Appl. No.: 09/947,895

(22) Filed: Sep. 6, 2001

(51) Int. Cl. B32B 7/06

(52) U.S. Cl. 428/40.1

(57) ABSTRACT

A self-closing resealable package material formed from paper, plastic, laminate or Tyvek® that is cohesively coated for initially sealing the package and where the material further includes a pressure sensitive adhesive for a second sealing of the same package and a liner to protect the pressure sensitive adhesive during the initial sealing of the package and prior to its use.

### FIELD OF INVENTION

This invention relates to a self-closing, adhesive-free, resealable, reusable packaging material for use in shipping articles or goods to a consumer, who may then re-use the same package for remailing the goods back to the sender when necessary.

### BACKGROUND ART

Resealable, reusable envelopes and packages are known in the art. For example, Greer et al., U.S. Pat. No. 6,032,854 discloses a multiple-use, sealable flat envelope, which has a body of spunbonded olefin with a closure flap that extends from and beyond the body and has two sections of adhesive so that the flap can be folded over the body and seal the package by one section of the adhesive and the other section of adhesive is protected by a liner for later use so that the package can be resealed.

Timm et al. U.S. Pat. No. 5,993,962 discloses a resealable package, which has a multiple reseal capability. The package includes a substrate with a layer of pressure sensitive adhesive and another layer of cold seal adhesive is applied over the layer of pressure sensitive adhesive. An additional layer of cold seal adhesive is applied to a second substrate. In use, the substrate is wrapped around a product to be packaged and the two cold seal adhesive strips are aligned, pressed together and thereby bonded. When the package is opened, the two substrates are pulled apart and the pressure sensitive adhesive is peeled off the substrate section, exposing the adhesive so that the package can be resealed using the exposed pressure sensitive adhesive. The drawback of this package is that it is critical to select appropriate adhesives for the proper functioning of the package. In other words, the adhesives chosen must be selected so that the bonds between the pressure sensitive adhesive and the cold seal adhesive, and the bonds between the cold seal adhesive and the substrate section, are stronger than the bond between the pressure sensitive adhesive and the substrate, otherwise, the pressure sensitive adhesive will not be cleanly pulled off the substrate upon pulling the substrates apart. Secondly, another drawback of this package is that if the substrate is not treated, some of the pressure sensitive adhesive will remain and will not be cleanly peeled off the substrate.

Resealable envelopes such as those disclosed in Kim U.S. Pat. No. 5,721,553 and Burns U.S. Pat. No. 4,690,322 are constructed for facilitating the remailing of correspondence and not goods. Kim discloses a mailable envelope, which is constructed to facilitate return mailing via the same envelope, which includes a front and back panel and a flap structure at the top for sealing the envelope. The receiver of the envelope may use the envelope by removing the outer front cover and utilizing the main front panel of the envelope for addressing the envelope and affixing postage. Likewise in Burns, the resealable envelope is not designed for reshipping merchandise through the postal system, and instead provides a resealable envelope which allows storage of documents.

In this new millennium and age of the Internet, there is a large increase in selling of merchandise over the Internet, e.g., e-commerce, in addition to the ordinary catalog sales and sales from fulfillment houses. These new, in addition to the old, types of transactions consequently cause a tremendous increase in the mailing and shipping of goods, sometimes across the country. Inevitably, the increase in shipping goods consequently causes an increase in returning those same goods to the shipper when the consumer is unsatisfied with the purchase. Therefore, a need exists for a convenient way to ship goods to consumers that can be easily returned to the shipper if the consumer so desires. The present invention fulfills such a need by providing a durable, weather-resistant, strong, self closing resealable package material with pressure sensitive adhesive strip which can be folded around a product to be packaged thereby forming a sealed package that can be reused to return the goods.

### SUMMARY OF INVENTION

The present invention provides a self-closing, resealable, package material with a strip of pressure sensitive adhesive. The packaging material forms a package when folded around a product or item to be packaged. The present invention offers consumers a convenient way to return goods to their sender in the same package and also offers a manufacturer a material for making a resealable package that has a simple and inexpensive construction.

In accordance with the present invention, the resealable packaging material generally includes: paper, plastic, laminates or Tyvek®.

The paper may be coated paper, Kraft paper, or higher quality paper such as Bond or white paper and has a thickness of from about 3 to 6 mils. The paper layer may be printable or metallized to obtain a decorative packaging material and the metallized paper layer may also be provided with graphics thereon.

The plastic may be comprised of a polymer selected from the group consisting of polypropylene, polyethylene and polyester and has a thickness of from about 0.5 to about 3 mils. The plastic packaging material may be oriented or biaxially oriented to impart high-strength thereto. The surfaces of the plastic layer may be corona discharge treated to render it receptive to inks and printing.

The packaging material may comprise a two-ply or a three-ply laminate. The two-ply laminate generally includes a paper layer and a water impermeable plastic film layer having a corona discharge treated surface. The first corona-discharge treated surface is adhesively laminated to the paper layer to form a paper-plastic laminate having first and second opposed outer surfaces. The paper layer of the laminate may be coated paper, Kraft paper, or higher quality paper such as Bond or white paper and has thickness of from at least about 3 to about 6 mils. The plastic layer component of the laminate typically comprises a polymer selected from the group consisting of polypropylene, polyethylene and polyester and has a thickness of at least about 0.5 to about 3 mils.

The three-ply laminate comprises a paper layer, a water impermeable plastic film layer having first and second corona discharge treated surfaces, and a second paper layer. The first corona-discharge treated surface is adhesively laminated to a paper layer and the second corona discharge treated surface is adhesively laminated to second paper layer to form a paper-plastic-paper laminate having first and second opposed outer surfaces. The first and second paper layers of the three-ply laminate may be coated paper, Kraft paper, or higher quality paper such as Bond or white paper and have a thickness of from at least about 3 to about 6 mils. The plastic layer component of the laminate typically comprises a polymer selected from the group consisting of polypropylene, polyethylene and polyester and has a thickness of at least about 0.5 to about 3 mils. The plastic layer may be oriented or biaxially oriented to impart high-strength thereto, and is cold laminated to the paper plys so that lamination is effected without heat, which impairs the orientation and strength of the plastic film ply.

The paper layers may have printable surfaces and may be metallized to obtain a decorative packaging material. The metallized paper layer may also be provided with graphics thereon.

In another embodiment the packaging material may comprise an olefin material such as Tyvek®.

In accordance with the present invention, the above-described packaging material additionally includes a layer of cohesive coating on at least a portion of one of its surfaces. The cohesive material has the property of sticking only to itself. Thus, when an article is placed on the cohesive coated surface of the laminate, the cohesive does not stick to the article. When the laminate is wrapped around the article the opposing cohesive coated surfaces come into contact with each other and form cohesive-cohesive bonds thereby enclosing the article within a defined internal space.

To make the package resealable, the packaging material additionally includes a strip of pressure sensitive adhesive, which is protected by a releasable liner that covers the pressure sensitive adhesive to protect it during the initial sealing of the package and prior to its use. The liner may comprise silicone treated paper, foil, or a composite material. The pressure-sensitive adhesive is applied to the packaging material at the time that the package is formed. For example, a package forming machine, which is well known in the art, applies a strip of pressure sensitive adhesive to the cohesively coated packaging material as it wraps the material around and about an article to be enclosed.

The packaging material may further comprise indicia to mark where the edge of a box or item to be enclosed should be placed. Additionally, the laminate may further include indicia positioned so that the formed package may be opened by cutting the laminate along at least part of the indicia.

When a recipient of the package wants to reseal the package after its opening, the recipient cuts along the indicia, which is positioned so that the user does not cut off the pressure sensitive adhesive and instead cuts off the edge of the package which contains cohesive. Thus, the pressure sensitive adhesive remains affixed to the package so that it may function to reseal the package by pulling off the liner to expose the adhesive.

### BRIEF DESCRIPTION OF THE DRAWINGS

For a better understanding of the invention, reference is made to the detailed description of the invention an the accompanying drawings therein:

FIG. 1 illustrates a flexible, paper-plastic laminate in accordance with the invention;

FIG. 2 illustrates the flexible, paper-plastic laminate being folded over so that opposing surfaces with cohesive material face each other.

FIG. 3 illustrates a box enclosed inside the resealable package formed from the laminate of the present invention.

FIG. 4 illustrates the cohesively coated laminate with a strip of pressure sensitive adhesive in accordance with the present invention.

FIG. 5 illustrates a laminate that is coated with cohesive around the perimeter of the laminate and further includes a strip of pressure sensitive adhesive.

FIG. 6 illustrates the formed resealable package with enclosed merchandise and indicia to mark location for cutting open the package.

FIG. 7 illustrates the packaging material of the present invention being folded over so that opposing cohesively coated panels are created.

FIG. 8 illustrates a releasable liner covering the pressure sensitive adhesive.

FIG. 9 illustrates the cohesively bonded edge of the formed resealable package with pressure sensitive adhesive covered by liner.

### DESCRIPTION OF THE PREFERRED EMBODIMENTS

The invention resides in a self-closing resealable packaging material formed from a package-forming material which encloses and seals an article therein, comprising: a packaging material in the form of at least one sheet having a surface that is receptive to receiving cohesive or adhesive materials, a cohesive material applied to surface portions of the packaging material, a pressure sensitive adhesive over at least part of the packaging material adjacent to where the article is to be packaged, and a liner placed upon the pressure sensitive adhesive to prevent the pressure sensitive adhesive from adhering to other portions of the packaging material, thus forming a non-adhered margin after the package is formed, wherein the packaging material is placed about an article to be packaged such that surface portions of the packaging material that include the cohesive material contact other portions that include cohesive material to adhere such portions to each other and form a sealed package which encloses the article with the non-adhered margin adjacent the article.

The package-forming material may be comprised of paper, plastic, laminate, which may be two-ply or three-ply, or olefin material such as Tyvek®.

In one embodiment the package-forming material is paper, which can be coated paper, Kraft paper, or higher quality paper such as Bond or white paper and has a thickness of from about 3 to 6 mils. The paper layer may be printable or metallized to obtain a decorative packaging material and the metallized paper layer may also be provided with graphics thereon.

In another embodiment the package-forming material is plastic, comprised of a polymer selected from the group consisting of polypropylene, polyethylene and polyester and has a thickness of from about 0.5 to about 3 mils. The plastic packaging material may be oriented or biaxially oriented to impart high-strength thereto. The surfaces of the plastic layer may be corona discharge treated to render it receptive to inks and printing.

In a further embodiment, the package forming-material is two-ply laminate, more specifically, a paper/plastic laminate, wherein a paper layer is cold laminated to a plastic film, layer. The paper layer of the laminate may include coated paper, Kraft paper, or a higher quality paper such as Bond paper or white paper. The paper layer preferably comprises Kraft paper and has a thickness of from about 3 to about 6 mils. The plastic film layer of the laminate may be oriented to impart high strength thereto. A biaxial orientation is preferred for greatest strength. The plastic film layer preferably comprises a polymer selected from the group consisting of polypropylene, polyethylene and polyester and has a thickness of from at least about 0.5 to 3 mils.

The plastic film layer has a first corona-discharge treated surface. This treatment is applied to the plastic immediately before the first corona discharge treated surface is adhesively laminated to the paper layer. This enables a strong bond to be achieved between the plastic and paper to form a paper-plastic film laminate having first and second opposed outer surfaces.

The cold lamination process enables the present packaging material to be manufactured at much higher speeds than when other adhesives, such as hot melt adhesives, are utilized, for example due to the additional time required for cooling of the hot melt adhesive before a secure bond is achieved. If hot melt adhesives were used instead of cold lamination for joining the plastic film to the paper, the heat of the adhesive could cause the film to shrink, thus causing a loss of strength. Also, the hot melt adhesive does not achieve its final bond strength until the adhesive cools, and the plastic film can shrink before this happens. Moreover, a wrinkled or curled product often results due to the difference in the high strength and low strength areas of the plastic film.

The use of cold lamination is also advantageous when an oriented or biaxially-oriented plastic film is utilized. It is known that at elevated temperatures, such films relax and lose molecular orientation and strength. For example, when two sheets of biaxially-oriented polyester film are seamed together, using an ultrasonically-activated sealing bar to create internal friction and heat within the film, the films soften and fuse, with a resultant sealing line that is weak, such that the sheets then tend to tear along this line. Similar problems are encountered if an oriented film is exposed to high heat, such as if a hot melt adhesive would be used to join the film to the paper. Cold lamination utilizing a water-based adhesive is essential in order to produce a laminate that has high strength. Any of a wide range or water-based adhesives can be used, although a vinyl acetate ethylene copolymer is preferred. The paper layer absorbs the water from these adhesives so that a high strength lamination can be rapidly achieved. U.S. Pat. No. 5,244,702 provides further details on this cold lamination process, and is incorporated herein to the extent necessary to understand this feature of the invention.

Another benefit of the use of a water-based adhesive is that this type of adhesive does not require the use of volatile organic solvents. Thus, adverse health and environmental effects are avoided because such solvents are not used. Also, additional costs for recovering or disposing of solvents are not incurred.

Depending on the type of packaging material desired, the packaging material may further include an additional paper layer to form a paper-plastic-paper, three-ply laminate sheeting. The extra paper layer may be desirable for packaging objects with pointed edges or simply when a packaging material with more strength is desired. As the paper layers form the inner and outer sides of the packaging material, they can easily be printed with graphics or other indicia prior to application of the cohesive material. This enables the packaging material to have one appearance on the outside of the package and another, different appearance on the side of the material that faces the package.

A cohesive material, which has the property of only sticking to itself, is applied to surface portions of the packaging material. It may be desirable in some situations to coat less than the entire surface of the packaging material. Accordingly, a screen type roller or rotary screen printing device can be used to selectively apply the coating upon only specific areas of the laminate sheeting. In addition, a spray head or series of spray heads may be used to selectively deposit a particular or random pattern. The pattern can be arranged to achieve a desired cohesive adhesion of the overall laminate sheeting. Alternatively, the coating can be applied to the entire outer surface of the packaging material.

The type and amount of cohesive coating to be applied will vary depending upon the results desired. For example, when packaging articles of a standard size, the packager may desire packaging material that does not have a layer of cohesive material applied to one entire surface of the laminate sheeting. Instead, it may be desirable that the packaging material has cohesive material coated only on the perimeter of the sheeting so that the packaging material does not have cohesive in the areas of the sheeting that would be covered by the article. Thus, less cohesive would be needed and the packaging material would be less costly and a more efficient use of cohesive would be provided.

A pressure sensitive adhesive is applied over at least a part of the packaging material by an automated wrapping machine as the machine is forming the package so that the resultant package will include a resealable feature due to the pressure sensitive adhesive. The pressure sensitive adhesive is adjacent to where an article to be packaged is placed and a liner is placed upon the pressure sensitive adhesive to prevent the adhesive from adhering to other portions of the packaging material, thus forming a non-adhered margin after the package if formed. In another embodiment, the pressure sensitive adhesive is applied to the packaging material before the formation of a package.

The packaging material of the present invention is preferably stored on a roll and dispensed therefrom as needed. Since the cohesive material only sticks to itself and only one surface of the packaging material contains the cohesive, when the packaging material is rolled up, the coated surfaces does not make contact with an opposing coated surface and no barriers are required to prevent the sheeting from sticking to itself while stored on the roll.

For applications, the packaging material can be used in automated wrapping equipment, wherein the resultant package is automatically wrapped by a machine generally known in the art, or alternatively the packaging material can be used in manual wrapping, wherein the packaging material is pulled off and cut from the roll, an article is placed on the surface of the packaging material and the packaging material is folded over and about the article.

In either method of wrapping an article, the opposing coated surfaces of the packaging material come into contact and form cohesive-cohesive bonds thereby enclosing the article with a non-adhering margin so that the package may be resealed a second time after its initial opening. Alternatively, instead of packaging an article with one unitary sheet of packaging material, it may be desirable to use two sheets of packaging material. At least one of the two sheets has a layer of cohesive and a strip of pressure sensitive adhesive and releasable liner. The two sheets of packaging material are placed on top of each other such that the cohesively coated surfaces of each unitary sheet of packaging material are opposing surfaces, the article is placed between the two sheets and the two sheets are placed in contact with each other so the contacted portions of the coated surfaces of the sheetings form cohesive-cohesive bonds and the article is enclosed within the packaging material, thereby forming a self-closing package with a non-adhering margin so that the package may be resealed after its initial opening.

One feature of the present invention is that it is capable of packaging articles of various sizes and shapes. The packaging material simply is pulled off the roll in an amount that accommodates the particular size of the particular article to be packaged.

In all embodiments, the exterior surface of the package may include a printable surface and such printable exterior surface may include a printed dotted line along the edge positioned so that the package may be opened by cutting along a pre-printed dotted line.

In addition, if desired a decorative package is provided in an embodiment wherein the exterior surface is metallized or aluminized. For example, the outer surface of the plastic film ply may be metallized as by vacuum deposition to provide a decorative package.

If a silver finish is desired, an aluminized surface is preferred. However, other metallizing treatments, e.g., copper, iron, or alloys, can be used when other colors are desired.

It also may be desirable that the packaging material have printable surfaces so that logos, messages, advertisements, emblems, trademarks or simply, addressee information etc., may be printed on the exterior or interior surfaces of the formed package. Thus, the decorative packaging material may include a printable surface of metallized paper. In this regard, the plastic film ply may include a second corona discharge treated surface to render it receptive to inks so that it may exhibit graphics that may be desired.

The Laminate Sheeting

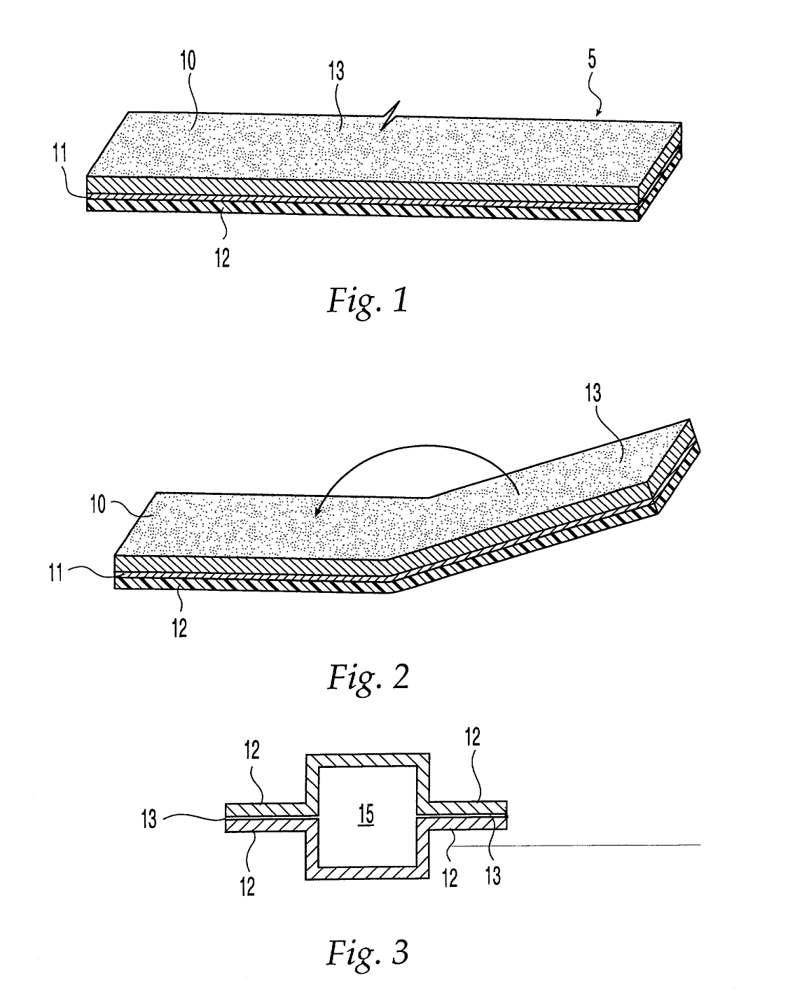

Referring to FIG. 1, shown therein is a unitary, flexible paper-plastic laminate sheeting of the present invention. Preferably the package is formed from one continuous sheet of two ply laminate, (paper/plastic) or three-ply laminate, (paper/plastic/paper). Alternatively, the package may be formed from two substrate panels, wherein each substrate panel is formed of two-ply laminate or three-ply laminate, in addition to paper, plastic or Tyvek®.

The laminate sheeting includes a paper facing ply 10 whose gauge, weight and quality are appropriate for the self-closing, resealable package and a plastic film ply (12).

The paper ply (10) is cold laminated by an adhesive layer (11) to a plastic film ply (12), such as polypropylene or polyester (MYLAR). The inner surface of the plastic ply is rendered wettable by a corona-discharge treatment to enhance the energy at this surface so that it is receptive to adhesives. The plastic film ply (12) is no greater than 3 mils in thickness and is at least 0.5 to 1 mil in thickness. The paper base ply (10) is thicker, preferably being 2 to 3 mils thick.

The plastic film is preferably biaxially-oriented, and has exceptional tensile strength. Such orientation is effected by stretching the film along both its transverse and horizontal axes to molecularly orient the film structure.

Cold lamination of the plies is effected by a water-based adhesive, preferably a water-based vinyl acetate ethylene copolymer composition having an affinity both for the paper ply and the film ply. No heat is applied to the oriented film as the plastic film ply is laminated to the paper ply. The water-based adhesive is fluid at ambient temperature and is not a hot melt adhesive. A water-based adhesive, once cured, is not water-soluble and is not remoistenable.

An oriented film, such as the one described, is heat-sensitive and at elevated temperatures, the film relaxes and loses its molecular orientation and strength. It is known, for example, that when two sheets of oriented polyester film are seamed together, using an ultrasonically-activated sealing bar for this purpose which creates internal friction and heat within the film, this causes the superposed films to soften and fuse. The resultant sealing line is weak, and consequently, the sheets tend to tear along this line. Clearly then, the utilization of cold lamination is essential to the present invention in order to produce paper-film laminate of high strength so that the resealable package can withstand the customary handling of packages in possession of the post.

It is to be noted that a synthetic plastic film material, such as polypropylene, is normally not receptive to adhesives, especially water-based adhesives. Therefore, if one were to apply to the surface of this film a water based adhesive which is flowable at ambient temperature or at a temperature somewhat above ambient but not at the elevated temperature of a hot melt adhesive, the adhesive will not be adsorbed by the film.

The paper ply of the laminate includes coated paper, Kraft paper, Bond paper or white paper and has a printable exterior. The plastic film ply includes a biaxially oriented film. The plastic film layer comprises: polypropylene, polyethylene, and polyester. The water impermeable plastic layer may have a first corona discharge treated surface making it more receptive to the cohesive material. In addition, the plastic film layer may have a second corona discharge treatment so that its surface is receptive to inks or other graphic materials. Further, the plastic ply or the paper ply may be metallized or aluminized so that a decorative package may be provided.

Referring to FIG. 2, the unitary sheeting of laminate may be folded over so that the cohesive material comes in contact so that cohesive bonds are formed between the cohesively coated surface of the laminate (13).

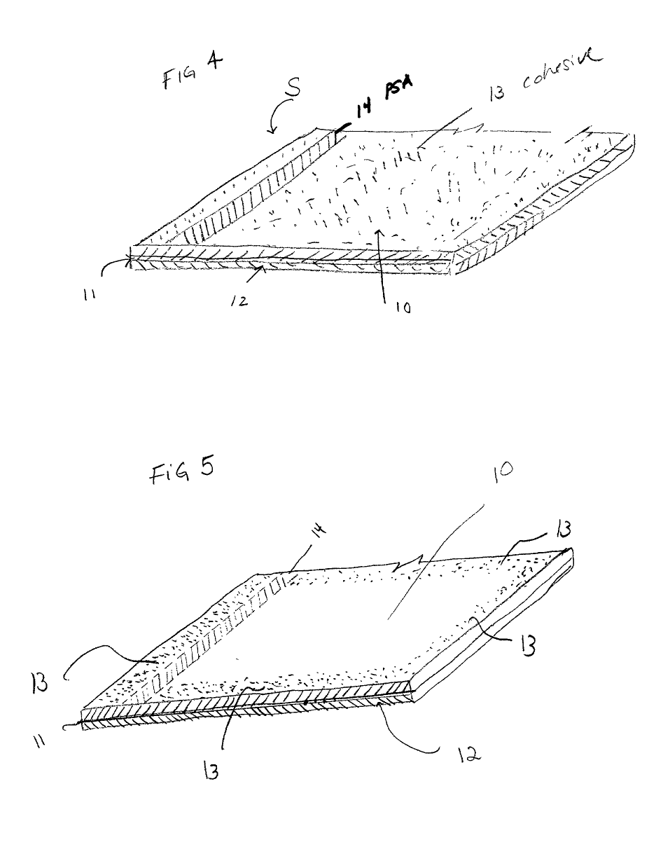

Referring to FIG. 3, the laminate sheeting of the invention is folded over and encloses a box (15) thereby creating a self closing resealable package.

Referring to FIG. 4, the laminate has a strip of pressure sensitive adhesive (14) across the cohesive (13) coated laminate.

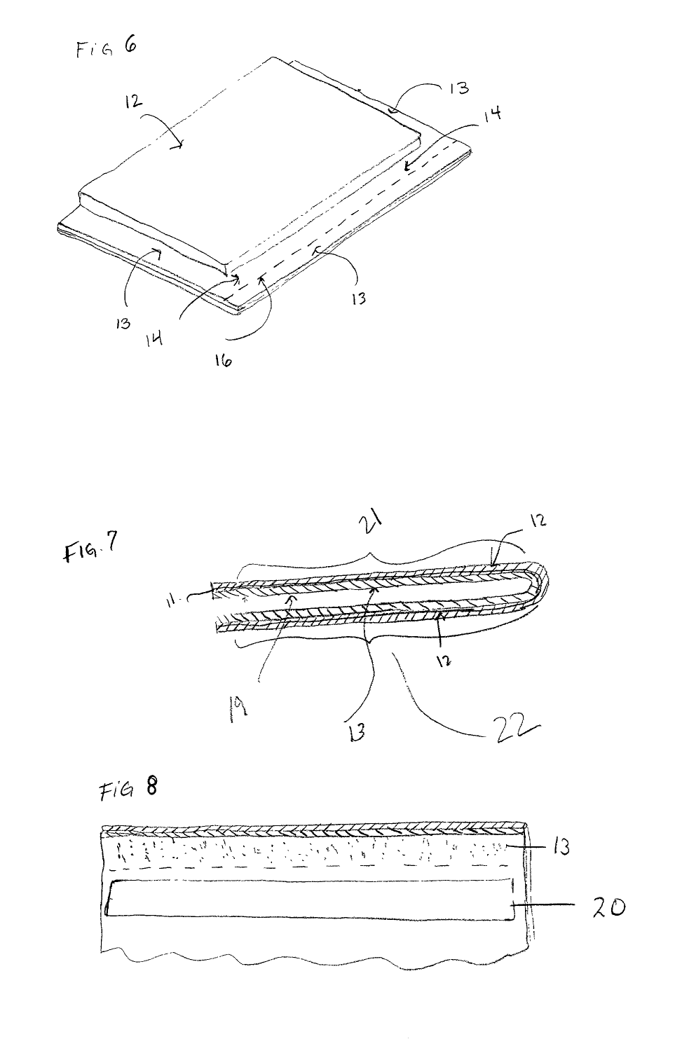

Referring to FIG. 5, the cohesive material (13) may cover a portion of the laminate sheeting leaving the center of the laminate cohesive-free.

Referring to FIG. 6, the resealable package of the invention is shown with enclosed merchandise (12) and indicia (16) positioned so that when cut along the pre-dotted line, the edge of the laminate with the cohesive material (13) is cut away from the package and the non-adhered margin (14) is left unimpaired and intact so that the recipient may reseal the package after its initial opening.

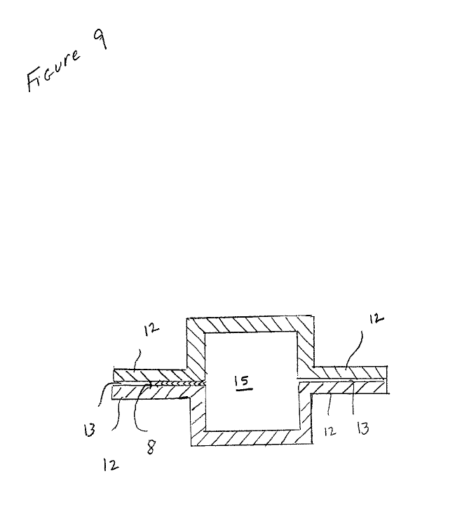

Referring to FIG. 7, the laminate is folded over so that first and second opposing substrate panels (21) and (22) are formed having an inner surfaces (20) that are coated with the cohesive material (13). The folding of the laminate sheeting defines an internal space for an enclosed article. When the two opposing substrate panels are aligned and in contact, cohesive-cohesive bonds form between the first and second opposing substrate panels thereby sealing the package.

Referring to FIG. 8, the packaging material of the invention has a release liner (20), which covers the pressure sensitive adhesive so that the pressure sensitive adhesive is protected during the initial sealing of the package and may later be used to reseal the package.

Referring to FIG. 9, the self-closing resealable package formed of a two ply laminate sheeting contains a box (15) and shows the non-adhering pressure sensitive adhesive (8) on the laminate.

Utilization of the Self-Closing Resealable Packaging Material with Pressure Sensitive Adhesive

A shipper of goods may package merchandise using the resealable, reusable mailer package by placing goods to be shipped on the cohesively coated substrate material. The cohesive material does not stick to the goods because cohesive material only sticks to itself. Thus, when the substrate sheeting is folded over the goods or alternatively when first and second substrate panels are aligned and placed in contact so that the cohesive material on the opposing panel or second panel come into contact, cohesive-cohesive bonds are formed which initially seal the package.

The packaging material further includes a strip of pressure sensitive adhesive, which is covered by a liner prior to its use. The liner protected pressure sensitive adhesive may be used to reseal the package after its initial opening.

When a recipient receives the goods in the mail, the package may be opened by cutting along a pre-printed dotted line so that the recipient may have access to the items enclosed in the package. If the recipient desires to return and remail the goods in the same package, the goods may be replaced into the same package and the package may be resealed by removing the liner and exposing the pressure sensitive adhesive so that the package may be resealed using the pressure sensitive adhesive.

What is claimed is:

1. A package-forming material for forming a package which encloses and seals an article therein, comprising:
a packaging material in the form of at least one sheet having a surface that is receptive to receiving cohesive or adhesive materials;
a cohesive material applied to surface portions of the packaging material;
a pressure sensitive adhesive over at least part of the packaging material adjacent to where the article is to be packaged; and
a liner placed upon the pressure sensitive adhesive to prevent the pressure sensitive adhesive from adhering to other portions of the packaging material, thus forming a non-adhered margin after the package is formed;
wherein the packaging material is placed about an article to be packaged such that surface portions of the packaging material that include the cohesive material contact other portions that include cohesive material to adhere such portions to each other and form a sealed package which encloses the article with the non-adhered margin adjacent the article.

2. The package-forming material of claim1 wherein the pressure sensitive adhesive is applied to the packaging material by an automated wrapping machine at the time that the package is being formed around an article.

3. The package-forming material of claim 1 wherein the packaging material is paper, plastic or a laminate of paper and plastic, and the adhered cohesive portions surround the article to be packaged.

4. The package-forming material of claim 1 wherein the packaging material is a laminate that includes a water impermeable plastic film having a first corona discharge treated surface that is adhesively cold laminated to a first paper layer.

5. The package-forming material of claim 3, wherein the packaging material is a laminate that includes a water impermeable plastic film having first and second corona discharge treated surfaces that are adhesively cold laminated to first and second paper layers.

6. The package-forming material of claim 1 wherein the cohesive material is present upon first and second surface portions of the packaging material and the package is formed by placing the first surface of the packaging material above the article to be packaged and by placing the second surface portion of the packaging material below the article to be packaged, such that the first and second surface portions of the packaging material that include the cohesive material contact and adhere to each other to form the sealed package which encloses the article.

7. The package-forming material of claim 5 wherein the first and second surface portions of the packaging material are provided on one side of a single sheet of the laminate and then folding the sheet around the article to be packaged to place the cohesive material containing portions in face-to-face orientation so that they can be adhered together to form the package.

8. The package-forming material of claim 6 wherein the cohesive material is present upon one entire surface of the laminate sheet.

9. The package-forming material of claim 5 wherein the first and second surface portions are provided as first and second laminate sheets which are placed above and below the article to be packaged with the cohesive material containing surface portions in face-to-face orientation so that they can be adhered together to form the package.

10. The package-forming material of claim 1 further comprising an indication of where the package can be opened wherein the indication enables the package to be opened in the non-adhered margin, such that the package may be resealed by removing the liner and adhering the pressure sensitive material to other surface portions to form a re-sealed package.

11. The package-forming material of claim 9 wherein, after opening the package along the indication and removing the article from the package, article can be replaced in the package; the liner removed and the package re-sealed by contacting the pressure sensitive material to other surface portions to adhere them together.

12. The package-forming material of claim 9 wherein the indication is an indicia or a pre-printed dotted line which indicates where the package may be cut to open it.

13. The package-forming material of claim 9 further comprising indicia to indicate where an edge or end of the article to be packaged should be placed.

14. The package-forming material of claim 9 wherein the liner is paper, plastic, foil or a composite material.

15. The package-forming material of claim 1 wherein packaging material is plastic that is corona discharge treated to render its surface receptive to inks or other graphic materials.

16. The package-forming material of claim 1 wherein the packaging material is metallized to provide a decorative package.

17. The package-forming material of claim 15 wherein the package forming material is aluminized.

18. The package-forming material of claim 1 wherein packaging material is a laminate wherein the plastic layer of the laminate is the printable exterior of the package and the paper layer is the interior thereof.

19. The package-forming material of claim 1 wherein the packaging material is a laminate wherein the paper layer of the laminate is the printable exterior of the package and the plastic layer is the interior thereof.
